(19) United States
(12) Patent Application Publication
(10) Pub. No.: US 2013/0325497 A1
(43) Pub. Date: Dec. 5, 2013

(54) CLINICAL INFORMATION DISPLAY APPARATUS, CLINICAL INFORMATION DISPLAY METHOD, AND CLINICAL INFORMATION DISPLAY PROGRAM

(71) Applicant: FUJIFILM Corporation, Tokyo (JP)

(72) Inventor: Shoji Kanada, Tokyo (JP)

(21) Appl. No.: 13/908,978

(22) Filed: Jun. 3, 2013

(30) Foreign Application Priority Data
Jun. 5, 2012 (JP) 2012-127646

(51) Int. Cl. G06F 19/00

(52) U.S. Cl. CPC G06F 19/345
USPC 705/2

(57) ABSTRACT

Based on summary extraction information in which each disease and each clinical information item extracted from a summary related information of at least one of (1) a treatment result summary, (2) a treatment review summary, (3) a history of a series of operations for generating the treatment result summary, and (4) a history of a series of operations for generating the treatment review summary are related, calculating a degree of appearance of each clinical information item, item by item, with respect to each disease as item information, determining a clinical information item whose calculated item information satisfies a predetermined condition as an important clinical information item, generating a display filter in which a disease and an important clinical information item corresponding to the disease are related, and displaying clinical information based on a display target disease and a display filter corresponding to the display target disease.

### BACKGROUND OF THE INVENTION

1. Field of the Invention

The present invention relates to a clinical information display apparatus for displaying important clinical information required for diagnosing a possible disease of a patient from a plurality of clinical information sets of the patient and operation method thereof, and a clinical information display program.

2. Description of the Related Art

Recently, in the medical field, when a diagnosis is performed, clinical information is displayed and used as the reference information for diagnosing the disease name and determining treatment policy or the like.

The clinical information includes various types of items (clinical information items) and if a patient is suspected to have a particular disease, clinical information is extracted from a clinical information item considered to be important (important clinical information item) for diagnosing the particular disease and the diagnosis is performed based on the extracted clinical information on an actual medical site. With the recent advancement of medical technologies, however, the clinical information items have diversified and there are many cases in which a large amount of clinical information is present for one patient, and it has become a heavy burden for the user to detect and display important clinical information required for the target patient. Consequently, a technology for automatically detecting and displaying important clinical information relevant to the disease of a patient from clinical information sets of the patient is expected.

In order to solve the problem described above, Japanese Unexamined Patent Publication No. 8(1996)-263562 discloses a technique in which a clinical information item required for diagnosis, such as a clinical information item falling outside of normal limits is retrieved from a disease information database according to the disease and displayed.

Further, in order to reduce the effort to select a required medical image from a large number of medical images of a given patient, Japanese Unexamined Patent Publication No. 2006-271541 proposes a technique in which priority levels are set to the images of the given patient based on the image operation history, such as reference frequency, the number of displays, insertion frequency when generating an image interpretation report of the patient.

Still further, U.S. Patent Application Publication No. 20040193022 proposes a technique in which, when new patient data are entered, a similarity level is obtained between clinical information of each case data of each of a plurality of target patients and the clinical information of the new patient data, and a disease having a highest similarity level is displayed with clinical information in the new patient data used for the calculation of the similarity level having a maximum influence.

### SUMMARY OF THE INVENTION

According to the technique described Japanese Unexamined Patent Publication No. 8(1996)-263562, knowledge and effort for setting an important clinical information item are required. It is difficult for a user having no knowledge of important clinical information with respect to the possible disease to set important clinical information according to the disease.

According to the technique described in Japanese Unexamined Patent Publication No. 2006-271541, the clinical information to be displayed is determined based only on the operation history of the clinical information of a given patient. For diagnostic efficiency, it is desirable that clinical information to be displayed is not determined for only the given patient but is shared among a plurality of patients having the same disease. The clinical information in the operation history includes both clinical information selected by a particular condition of the given patient and important clinical information relevant to the disease. Therefore, it is not considered to be appropriate to directly use the clinical information displayed for the given patient as important clinical information of patients other than the given patient.

According to the technique described in U.S. Patent Application Publication No. 20040193022, a disease having similarity between the clinical information of a new patient and clinical information of case data based also on clinical information poorly related to a possible disease of the new patient is presumed independently of a possible disease of a new patient and relevant important clinical information for the disease. Consequently, in the case where clinical information having a poor relation with the possible disease of the new patient is similar to the clinical information of case data, the possible disease may be erroneously presumed. In this case, clinical information having no relation with the possible disease of the new patient is likely to be displayed.

Under the circumstances described above, a technique that allows important clinical information regarded as important for diagnosis to be set appropriately and easily is demanded.

The present invention has been developed in view of the circumstances described above, and it is an object of the present invention to provide a clinical information display apparatus for automatically determining an important clinical information item required for diagnosing each disease from clinical information items of the past cases, operation method thereof, and a clinical information display program.

A clinical information display apparatus according to the present invention is an apparatus, including:

a summary extraction information obtaining unit for obtaining, with respect to a plurality of patients, at least one of (1) a treatment result summary in which a disease and clinical information of a patient is summarized for indicating a diagnostic result or a treatment result, (2) a treatment review summary in which a possible disease and clinical information of the patient is summarized for reviewing diagnosis or treatment (3) a history of a series of operations for generating the treatment result summary, and (4) a history of a series of operations for generating the treatment review summary as summary related information, and obtaining summary extraction information in which each disease and each clinical information item representing a type of clinical information extracted from the obtained summary related information of the plurality of patients are related;

an item information calculation unit for calculating a degree of appearance of each clinical information item, item by item, with respect to each disease as item information based on the summary extraction information;

a display filter generation unit for determining a clinical information item whose calculated item information satisfies a predetermined condition as an important clinical information item and generating a display filter in which a disease and an important clinical information item corresponding to the disease are related; and

a display control unit for obtaining a disease of a display target patient as a display target disease and obtaining clinical information of the display target patient corresponding to the important clinical information item for display on a display unit based on a display filter corresponding to the obtained display target disease.

A clinical information display method of the present invention is a method for use with a clinical information display apparatus which includes a summary extraction information obtaining unit, an item information calculation unit, a display filter generation unit, and a display control unit, the method including the steps of:

obtaining, with respect to a plurality of patients, at least one of (1) a treatment result summary in which a disease and clinical information of a patient is summarized for indicating a diagnostic result or a treatment result, (2) a treatment review summary in which a possible disease and clinical information of the patient is summarized for reviewing diagnosis or treatment (3) a history of a series of operations for generating the treatment result summary, and (4) a history of a series of operations for generating the treatment review summary as summary related information and obtaining summary extraction information in which each disease and each clinical information item representing a type of clinical information extracted from the obtained summary related information of the plurality of patients are related;

calculating a degree of appearance of each clinical information item, item by item, with respect to each disease as item information based on the summary extraction information;

determining a clinical information item whose calculated item information satisfies a predetermined condition as an important clinical information item and generating a display filter in which a disease and an important clinical information item corresponding to the disease are related; and

obtaining a disease of a display target patient as a display target disease and obtaining clinical information of the display target patient corresponding to the important clinical information item for display on a display unit based on a display filter corresponding to the obtained display target disease.

A clinical information display program of the present invention is a program for causing a computer to function as:

a summary extraction information obtaining unit for obtaining, with respect to a plurality of patients, at least one of (1) a treatment result summary in which a disease and clinical information of a patient is summarized for indicating a diagnostic result or a treatment result, (2) a treatment review summary in which a possible disease and clinical information of the patient is summarized for reviewing diagnosis or treatment (3) a history of a series of operations for generating the treatment result summary, and (4) a history of a series of operations for generating the treatment review summary as summary related information, and obtaining summary extraction information in which each disease and each clinical information item representing a type of clinical information extracted from the obtained summary related information of the plurality of patients are related;

an item information calculation unit for calculating a degree of appearance of each clinical information item, item by item, with respect to each disease as item information based on the summary extraction information;

a display filter generation unit for determining a clinical information item whose calculated item information satisfies a predetermined condition as an important clinical information item and generating a display filter in which a disease and an important clinical information item corresponding to the disease are related; and

a display control unit for obtaining a disease of a display target patient as a display target disease and obtaining clinical information of the display target patient corresponding to the important clinical information item for display on a display unit based on a display filter corresponding to the obtained display target disease.

The “treatment result summary” described above may be any summary information as long as a disease of each patient and clinical information, such as treatment contents for the disease of the patient are summarized therein, and a typical example may be a discharge summary. Generally, the discharge summary summarizes the progress and treatment contents of a patient from the hospitalization to discharge and includes a final diagnosed disease name, outcome, and the like.

The “treatment review summary” described above may be any summary information as long as a possible disease of each patient and clinical information, such as treatments content for the possible disease of the patient are summarized therein, and a typical example may be a conference summary which includes a possible disease of a patient and clinical information to be shared by doctors and used in a conference for reviewing the possible disease of the patient and treatment policy. Generally, the conference summary includes a possible disease of a patient, progress, treatment contents, and the like.

The phrase “history of a series of operations for generating the treatment result summary or “history of a series of operations for generating the treatment review summary” as used herein refers to the history of operations performed by a user with the use of an input device such as a keyboard, pointing device, or touch panel and predetermined processing performed in processing units according to the user operations for generating the treatment result summary or treatment review summary. The history may include, by way of example, operations for opening and closing files of electronic medical record, treatment content, and various examination results (electronic medical record file and the like), operations for selecting information included in the electronic medical record file and the like, operations for inserting information copied from the electronic medical record file and the like into the treatment result summary or treatment review summary, and operations for inputting a diagnosed disease name, other progress information, and the like. The history of a series of operations for generating the treatment result summary or treatment review summary includes not only the history of operations for newly generating the treatment result summary or treatment review summary but also the history of operations for editing the already generated treatment result summary or treatment review summary. Further, the history of a series of operations for generating the treatment result summary or treatment review summary may not be the entire operation history but a portion thereof when the treatment result summary or treatment review summary is newly generated.

The term “clinical information” as used herein refers to information of a patient obtained for diagnosis which may be obtained through examination of a patient, declaration from the patient, and the like. Further, the “clinical information” may be any information as long as it is information of a patient obtained for diagnosis, and may include basic patient information, such as blood pressure, pulsation, age, gender, body weight, body temperature, number of respirations, and the like, family history, various examination result data, various image findings and image characteristic amounts, medication/treatment content, treatment result, gene information, severity level, and the like.

The term “clinical information item” as used herein refers to an item representing a type of clinical information, which may be provided by categorizing the types of clinical information by various methods. For example, a blood pressure, pulsation, age, gender, body weight, body temperature, number of respirations, or the like may be a clinical information item with respect to basic patient information, an examination item may be a clinical information item with respect to blood examination, a modality type may be a clinical information item with respect to image inspection, and a type of medicine may be a clinical information item with respect to medication information.

Further, the “item information” may be any information as long as it represents a degree of appearance of each clinical information item, item by item, with respect to each disease, and an appearance frequency of each clinical information item in the summary related information with respect to each disease may be used as the item information.

The “display target patient” described above may be a patient included in the “plurality of patient” or a patient not included in the “plurality of patient”.

Preferably, the clinical information display apparatus of the present invention further includes a change information obtaining unit for obtaining, based on clinical information of the display target patient displayed by the display control unit, a clinical information item changed from display to non-display or a clinical information item changed from non-display to display as change information, and a display filter change unit for changing, based on the display target disease and change information corresponding to the display target disease, the important clinical information item of the display filter.

Preferably, the clinical information display apparatus of the present invention further includes a change information obtaining unit for obtaining, based on clinical information of the display target patient displayed by the display control unit, a clinical information item changed from display to non-display or a clinical information item changed from non-display to display as change information, and the item information calculation unit is a unit that calculates the item information by calculating a degree of appearance of each clinical information item with respect to each disease based also on the display target disease and change information corresponding to the display target disease.

Preferably, in the clinical information display apparatus of the present invention, the summary extraction information obtaining unit is a unit that calculates the summary extraction information using an operation for selecting and inserting clinical information into the treatment result summary and/or the treatment review summary and an operation for selecting and deleting clinical information from the treatment result summary and/or the treatment review summary in the history of a series of operations for generating the treatment result summary and/or the history of a series of operations for generating the treatment review summary.

The “operation for selecting and inserting clinical information into the treatment result summary and/or the treatment review summary” may be any operation as long as it selects and inserts clinical information into the treatment result summary and/or the treatment review summary. For example, the “operation for selecting and inserting clinical information into the treatment result summary and/or the treatment review summary” is not necessarily includes an insertion operation itself and in the case where an input application that selects and inserts clinical information into the summary only by an selection operation with a pointing device, such as a mouse or the like, the selection operation with a pointing device, such as a mouse or like, corresponds to the “operation for selecting and inserting clinical information into the treatment result summary and/or the treatment review summary”.

The “operation for selecting and deleting clinical information from the treatment result summary and/or the treatment review summary” may be any operation as long as it selects and deletes clinical information from the treatment result summary and/or the treatment review summary. For example, the “operation for selecting and deleting clinical information from the treatment result summary and/or the treatment review summary” is not necessarily includes a deleting operation itself and in the case where an input application that selects and deletes clinical information from the summary only by an selection operation with a pointing device, such as a mouse or the like, the selection operation with a pointing device, such as a mouse or like, corresponds to the “operation for selecting and deleting clinical information from the treatment result summary and/or the treatment review summary”.

Preferably, when calculating summary extraction information, the degree of appearance in the summary related information is increased by the “operation for selecting and inserting clinical information into the treatment result summary and/or the treatment review summary” and decreased by the “operation for selecting and deleting clinical information from the treatment result summary and/or the treatment review summary”.

Preferably, in the clinical information display apparatus of the present invention, the item information is information representing an appearance frequency of each clinical information in the summary extraction information, and the display filter generation unit is a unit that determines a clinical information item whose appearance frequency is greater than a predetermined threshold value to be an important clinical information item based on the item information.

Further, in the clinical information display apparatus of the present invention, the display filter generation unit may be a unit that further determines an important clinical information item of the predetermined disease based on a likelihood ratio obtained by dividing a conditional probability of appearance of the clinical information item in a case corresponding to the predetermined disease by a conditional probability of appearance of the clinical information item in a case not corresponding to the predetermined disease based on the summary extraction information.

The phrase, further determines an important clinical information item “based on a likelihood ratio”, may be, for example, the case in which a clinical information item having a likelihood ratio grater than or equal to a threshold value is determined to be an important clinical information item by the display filter generation unit. The threshold value may be set arbitrarily as long as it allows the depth of connection of a clinical information item to a disease (certainty that the clinical information item corresponds to the disease) to be evaluated relatively large based on the value of the likelihood ratio and, for example, a value of not less than 1.5 is preferable and a value of not less than 2.0 is more preferable.

Preferably, in the clinical information display apparatus of the present invention, the clinical information includes medication information representing a medicine and the summary extraction information obtaining unit is a unit that calculates the summary extraction information by relating the medication information to each disease with a plurality of medicines classified into the same category being treated as one medicine.

Preferably, in the clinical information display apparatus of the present invention, an important clinical information item is related to each of a plurality of display steps in the display filter and display mode of the clinical information corresponding to the important clinical information item of the display target patient is changed according to the display step.

With respect to the “display mode of the clinical information corresponding to the important clinical information item of the display target patient is changed according to the display step”, various methods for changing the display mode of clinical information corresponding to the important clinical information item according to the display step may be employed. For example, two-step display levels may be set to each important clinical information item and clinical information corresponding to an important clinical information item having a greater display level is displayed in detail and clinical information corresponding to an important clinical information item having a smaller display level is displayed in a simplified manner. Further, for example, clinical information corresponding to an important clinical information item may be displayed distinguishably by changing the color or size thereof according to the display step.

Preferably, in the clinical information display apparatus of the present invention, the item information calculation unit is a unit that calculates the item information with respect to each disease with a plurality of diseases classified into the same category being treated as one disease.

According to the present invention, at least one of (1) a treatment result summary in which a disease and clinical information of a patient is summarized for indicating a diagnostic result or a treatment result, (2) a treatment review summary in which a possible disease and clinical information of the patient is summarized for reviewing diagnosis or treatment (3) a history of a series of operations for generating the treatment result summary, and (4) a history of a series of operations for generating the treatment review summary is obtained with respect to a plurality of patients as summary related information and summary extraction information is obtained in which each disease and each clinical information item representing a type of clinical information extracted from the obtained summary related information are related, a degree of appearance of each clinical information item is calculated, item by item, with respect to each disease as item information based on the summary extraction information, a clinical information item whose calculated item information satisfies a predetermined condition is determined as an important clinical information item and a display filter is generated in which a disease and an important clinical information item corresponding to the disease are related, and a disease of a display target patient is obtained as a display target disease and obtaining clinical information of the display target patient corresponding to the important clinical information item is obtained for display on a display unit based on a display filter corresponding to the obtained display target disease. As the treatment result summary and treatment review summary summarize clinical information determined to be important by the user for a disease of a patient or for determining the disease or treatment policy of the disease, it is less likely that clinical information not related to the diagnosis or treatment of the disease is included and it is very likely that only the clinical information considered to be important for the diagnosis or treatment of the disease is included in such summaries. Thus, by determining an important clinical information item with respect to each disease based on the treatment result summary, treatment review summary, and the history of a series of operations for generating these summaries, erroneous determination of clinical information not related to the diagnosis of the disease to be important clinical information may be prevented. Thus, the display filter may be generated by determining an important clinical information item through appropriate discrimination of important clinical information from the other clinical information, and the use of the filter may reduce the efforts of the user to retrieve and edit important clinical information of the display target patient, whereby only important clinical information may be displayed accurately and easily. Further, the display of the clinical information of the display target patient by reducing unnecessary clinical information allows doctors to understand important clinical information easily and to carry out the diagnosis effectively.

### BRIEF DESCRIPTION OF THE DRAWINGS

FIG. 1 schematically illustrates a configuration of a medical information system to which a clinical information display apparatus according to an embodiment of the present invention is applied.

FIG. 2 illustrates, by way of example, a summary related information generation method according to an embodiment of the present invention.

FIG. 3 is a flowchart illustrating a flow of generating a display filter according to an embodiment of the present invention.

FIG. 4 is a flowchart illustrating a flow of displaying clinical information according to an embodiment of the present invention.

FIG. 5 illustrates a flow of generating a display filter according to a modification of the embodiment of the present invention.

### DESCRIPTION OF THE PREFERRED EMBODIMENTS

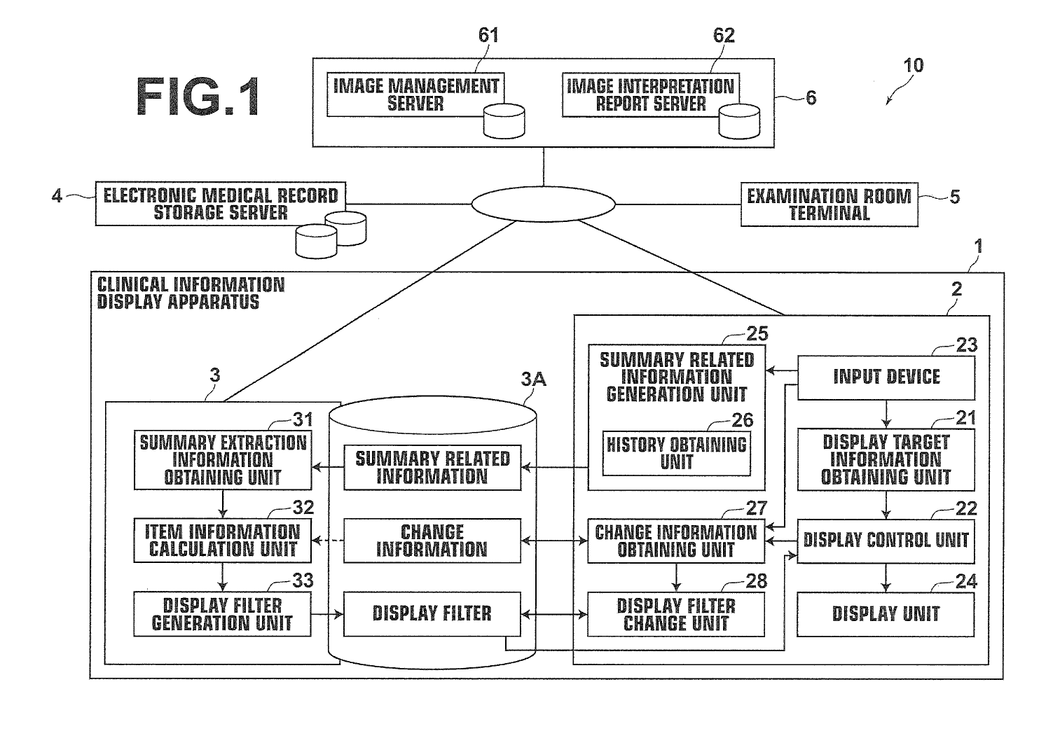

An aspect of the clinical information display apparatus of the present invention will be described with reference to the accompanying drawings. FIG. 1 schematically illustrates a configuration of a medical information system to which a clinical information display apparatus according to an embodiment of the present invention is applied. It is a functional block diagram of the clinical information display apparatus of a first embodiment.

As illustrated in FIG. 1, a medical information system 10 is configured by a medical information management server 3, an electronic medical record storage server 4, a diagnosis and treatment department terminal 2, an examination room terminal 5, and image diagnosis system 6 which are communicatively linked via a network 7.

The electronic medical record storage server 4 is provided with an electronic medical record database storing electronic medical records and communicatively linked to the medical information management server 3, diagnosis and treatment department terminal 2, examination room terminal 5, and image diagnosis system 6 via the network 7.

A clinical information display apparatus 1 according to the present embodiment is formed of the medical information management server 3 and diagnosis and treatment department terminal 2 linked via the network 7. Each computer of the medical information management server 3 and diagnosis and treatment department terminal 2 is controlled by a program installed from a recording medium, such as a CD-ROM or the like, and functions as the clinical information display apparatus 1 of the present embodiment. The program may be a program downloaded from a storage device of a server linked via a network, such as the Internet or the like, and installed after that.

The medical information management server 3 is a computer provided with a summary related information database 3A. The medical information management server 3 includes clinical information display application software installed thereon for realizing a clinical information display processing according to the present embodiment, in addition to an operating system, database management software. The medical information management server 3 functions as a summary extraction information obtaining unit 31 for obtaining summary related information to be described later and obtaining summary extraction information in which each disease and each clinical information item representing a type of clinical information extracted from the obtained summary related information are related, an item information calculation unit 32 for calculating an appearance frequency of each clinical information item, item by item, with respect to each disease as item information based on the summary extraction information, and a display filter generation unit 33 for determining a clinical information item whose calculated item information satisfies a predetermined condition as an important clinical information item, and generating a display filter in which a disease and an important clinical information item corresponding to the disease are related.

The diagnosis and treatment department terminal 2 is a computer used by a doctor of the diagnosis and treatment department or the like for viewing clinical information of a patient, entering an examination order, and the like, and includes a display unit 24 which is a common display and an input device 23 which includes a keyboard and mouse. The diagnosis and treatment department terminal 2 is also used for generating a discharge summary and a conference summary to be described later based on the results of examinations performed in each diagnosis and treatment department and information of generated electronic medical records, and includes standard software, such as operating system, and application software for entering the discharge summary and conference summary.

The diagnosis and treatment department terminal 2 includes clinical information display application software for realizing clinical information display processing of the present embodiment and functions as the following units: a display target information obtaining unit 21 for obtaining a disease of a display target patient (display target disease) and clinical information of the display target patient; a display control unit 22 for obtaining clinical information of the display target patient corresponding to the important clinical information item based on a display filter corresponding to the display target disease for display on the display unit 24; a summary related information generation unit 25 for generating summary related information; a change information obtaining unit 27 for obtaining, as change information, a clinical information item changed from display to non-display or a clinical information item changed from non-display to display based on the clinical information of the display target patient displayed by the display control unit; and a display filter change unit 28 for changing an important clinical information item of the display filter based on the change information. The summary related information generation unit 25 includes a history obtaining unit 26 for obtaining, when a discharge summary is generated, a history of a series of operations for generating the discharge summary.

The examination room terminal 5 is a computer provided in an examination room separate from each diagnosis and treatment department and used for entering results of examination performed in the examination room according to the examination order entered from each of the diagnosis and treatment department terminal 2. The computer includes software for viewing an examination order and entering examination results, in addition to standard software, such as an operation system or the like. The examination result information performed in each examination room is entered from the examination room terminal 5 in association with the examination order or a patient ID. In the present embodiment, the electronic medical record storage server 4 functions also as a management server for examination result information and the entered examination result information is stored in an examination result database provided in the electronic medical record storage server 4.

The image diagnosis system 6 is a known computer system and is of a configuration in which an image diagnosis medical workstation (not shown), a modality (not shown), such as CT, MRI or the like, an image management server 61 having an image database storing image data obtained by the MRI, and an image interpretation report server 62 having an image interpretation report database storing an image interpretation report which includes image interpretation results of the obtained image, which are communicatively linked via the network 7. The image diagnosis medical workstation includes various types of image analysis software and is configured to be able to perform various types of image analysis processing according to the purpose and target of the diagnosis.

The clinical information display processing of the present embodiment may be divided into three stages: a stage for generating summary related information (summary related information generation stage); a stage for generating a display filter (display filter generation stage); and a stage for displaying clinical information of a display target patient (display stage). Hereinafter, each processing performed in the aforementioned three stages by each functional block of the clinical information display apparatus 1 will be described stage by stage.

### <Summary Related Information Generation Stage>

In the present embodiment, the summary related information generation unit 25 generates a discharge summary or a conference summary base on a user input operation and stores the generated summary in the summary related information database 3A as summary related information. The history obtaining unit 26 provided in the summary related information generation unit 25 obtains, when a discharge summary or a conference summary is newly generated, a history of a series of operations for generating the discharge summary or the conference summary and stores the generated history in the summary related information database 3A as summary related information.

The summary related information database 3A stores therein summary related information generated by the diagnosis and treatment department terminal 2 and a multitude of summary related information generated by other medical information systems and copied into the medical information system 10. Each of a multitude of summary related information is information representing any of a discharge summary (treatment result summary), a conference summary (treatment review summary), a history of a series of operations for generating the discharge summary, or a history of a series of operations for generating the conference summary. In the case where both the summary related information representing a discharge summary and summary related information representing the history of a series of operations for generating the discharge summary are present with respect to the same disease of the same patient, each processing such as summary extraction information calculation processing, item information calculation processing, or the like included in the filter generation stage to be described later is performed using only the history of a series of operations for generation the discharge summary or the like in order to avoid the use of summary related information duplicated in content.

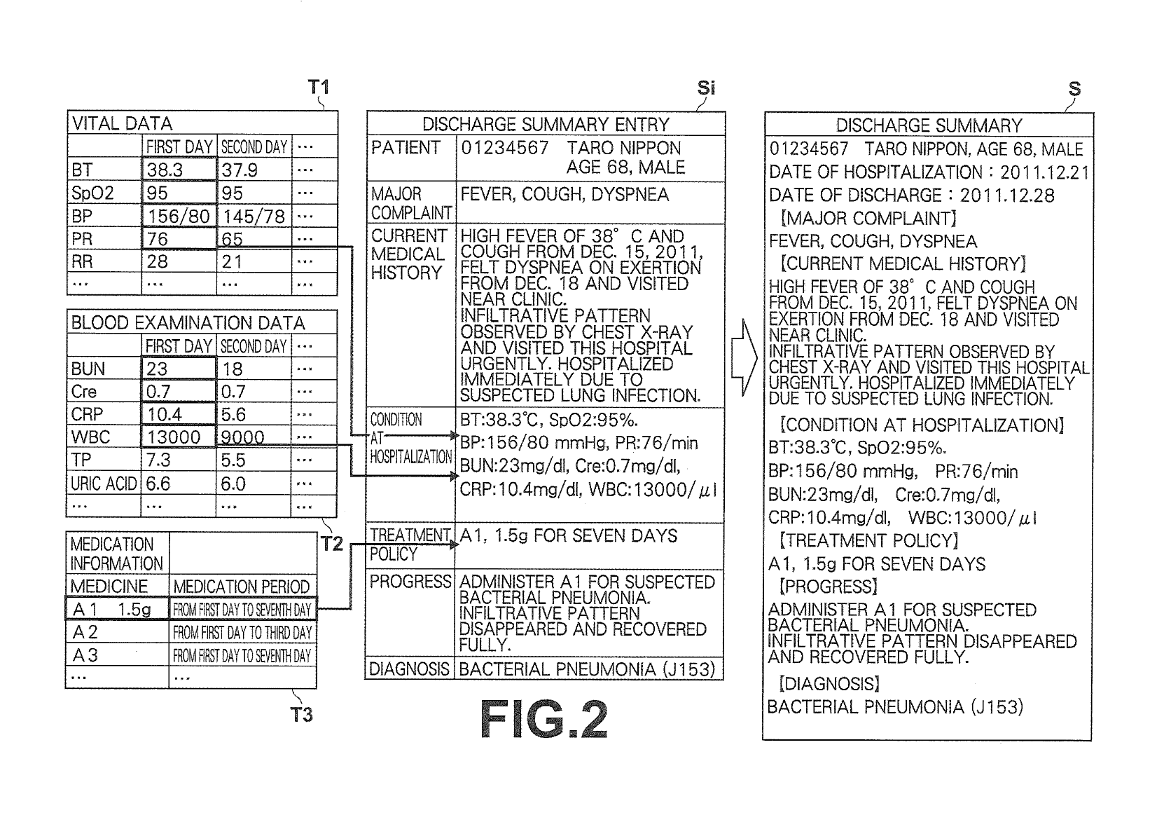

FIG. 2 illustrates, by way of example, a method for generating a discharge summary. As illustrated in a discharge summary S in FIG. 2, the discharge summary S herein is a summary in which a disease and clinical information representing progress/treatment content from the hospitalization to discharge are summarized. The conference summary summarizes, with respect to each diagnosis target patient, a possible disease and clinical information representing the progress of the disease/treatment content for the patient and is used in a conference of medical experts, such as doctors, for sharing information of a case of each diagnosis target patient by referencing the possible disease and clinical information and reviewing the information of the case of the diagnosis target patient and treatment policy.

An example flow for a user to generate a discharge summary S of a patient will be described with reference to FIG. 2. First, the user activates a discharge summary generation application and displays a discharge summary entry window Si on the display unit 24. Then, with respect to a target patient for which a discharge summary S is to be generated, the user retrieves an electronic medical record and clinical information sets, including vital data T1 (basic data representing basic information of the patient), blood examination data T2, medication information T3, and the like, from the electronic medical record server and the like, then loads them on the diagnosis and treatment department terminal 2, and displays them on the display unit 24. Then the user enters necessary information in each of the columns of patient, major complaint, current medical history, progress, and diagnosis with a keyboard or a mouse with reference to the displayed clinical information data.

When information of the thick frame portions in FIG. 2 is selected by the user by operating the input device 23 with respect to the vital data, blood examination data, and medication information, the summary related information generation unit 25 receives user selection operations, identifies a clinical information item corresponding to the clinical information in the selected thick frames, and inserts the selected clinical information and clinical information item corresponding to the clinical information into the discharge summary entry window Si. In addition, with respect to each of the columns of patient, major complaint, current medical history, progress, and diagnosis, if an operation for selecting an item to be entered into each column from the electronic medical record and inserting the selected item into each pertinent column of the discharge summary entry window (copy and paste operation) using a mouse is repeated by the user, the summary related information generation unit 25 receives the selecting and inserting operation and inserts the selected item into each of the pertinent columns of patient, major complaint, current medical history, progress, and diagnosis.

When the entry of each column of the discharge summary entry window Si is completed and the discharge summary generation application is closed by the user, the summary related information generation unit 25 stores the generated discharge summary in the summary related information database 3A via the medical information management server 3.

Further, in the present embodiment, the history obtaining unit 26 obtains a history of operations after the discharge summary generation (or conference summary generation) application is activated until it is closed as the history of “a series” of operations and stores the history in the summary related information database 3A as summary related information. More specifically, when the discharge summary generation (or conference summary generation) application is activated, the history obtaining unit 26 determines that the generation of a discharge summary or a conference summary (hereinafter, a discharge summary or a conference summary is referred to as the “discharge summary or the like”) is initiated and starts storing a history of operations from the input device 23. When the discharge summary generation (or conference summary generation) application is closed, the history obtaining unit 26 determines that the generation of the discharge summary or the like is completed and terminates the storing of the history of operations from the input device 23. The history obtaining unit 26 obtains a history of operations according to the activation and termination of the discharge summary generation (or conference summary generation) application not only the case where a discharge summary or the like is newly generated but also the case where the discharge summary or the like is edited. The history obtained by the history obtaining unit 26 is stored in the summary related information server 3A by the medical information management server 3 as summary related information via the network.

For example, in the case where a discharge summary shown in FIG. 2 is to be generated, the history obtaining unit 26 obtains, as a history of a series of operations, in chronological order (i) a history of operations for selecting and displaying an electronic medical record and clinical information data, such as a vital data T1, blood examination data T2, medication information T3, and the like (ii) a history of operations by the user for selecting clinical information of the thick frame portions in FIG. 2 and inserting the selected clinical information and clinical information items corresponding to the selected clinical information into the discharge summary entry window Si with respect to the vital data, blood examination data, and medication information, and (iii) a history of operations by the user for selecting an item to be entered into each of the columns of patient, major complaint, current medical history, progress, and diagnosis from the electronic medical record and inserting the selected item into each pertinent column of the discharge summary entry window, and stores the obtained history of a series of operations in the summary related information database 3A via the medical information management server 3. As described above, the history of a series of operations includes not only the operations themselves but also a series of processing performed by the diagnosis and treatment department terminal 2 in response to the operations.

### <Display Filter Generation Stage>

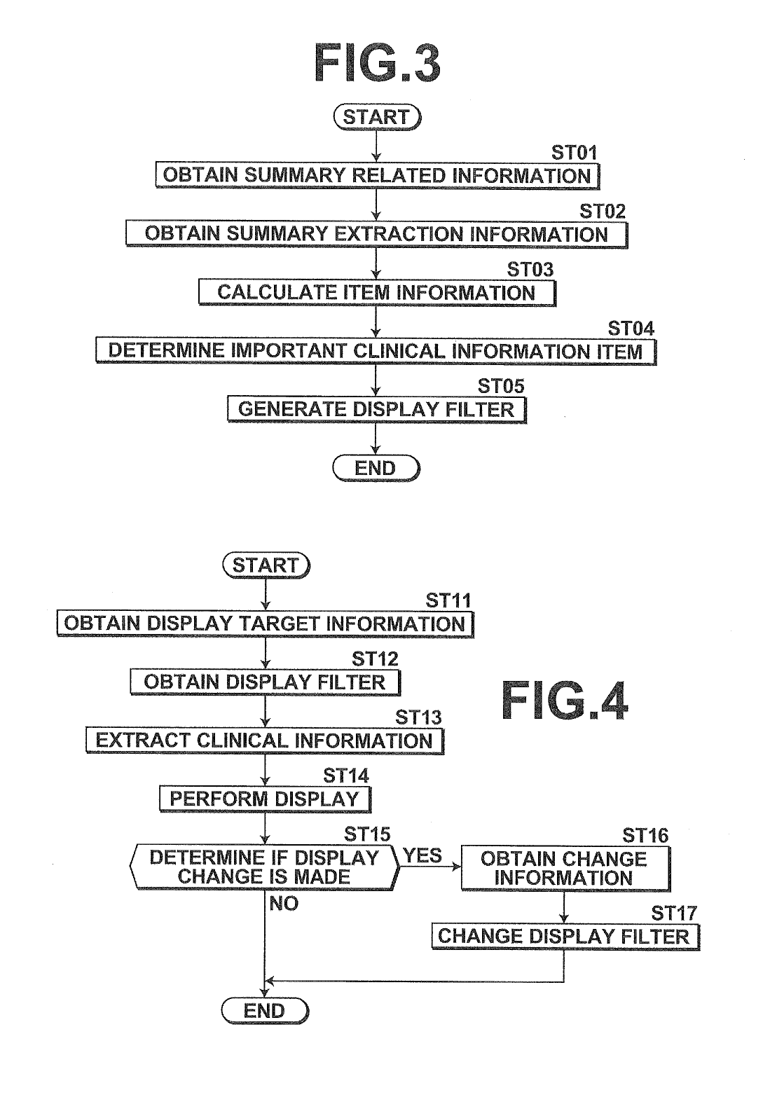

FIG. 3 is a flowchart illustrating a flow of processing performed in the display filter generation stage. The flow of processing performed in the display filter generation stage will be described with reference to FIG. 3.

First, the summary extraction information obtaining unit 31 obtains summary related information of a plurality of patients stored in the summary related information database 3A (ST01).

Next, the summary extraction information obtaining unit 31 obtains summary extraction information which is information generated by extracting a disease and a clinical information item representing a type of clinical information from the obtained summary related information and associating them with each other (ST02).

The summary extraction information obtaining unit 31 performs a natural language processing analysis on the obtained summary related information to determine whether or not a pre-registered disease or a clinical information item is included in the summary related information and extracts the disease and clinical information item. Then, with respect to each of the summary related information, the summary extraction information obtaining unit 31 obtains summary extraction information which is information in which a disease (disease code, here), clinical information items, and the number of appearances of each clinical information item in the summary related information are associated.

For example, summary extraction information shown in Table 1 below is calculated from the history of operations for generating the discharge summary shown in FIG. 2. Note that the summary extraction information obtaining unit 31 counts the number of appearances of each clinical information item in the summary related information with a plurality of medicines belonging to the same category being treated as one medicine. As illustrated in FIG. 2, if a medicine A1 is included in the summary related information as a clinical information item, the summary extraction information obtaining unit 31 counts the number of appearances of the clinical information item in the summary related information by replacing the medicine A1 with an antibacterial agent which is the type of medicine to which the medicine A1 belongs. The summary extraction information obtaining unit 31 of the present embodiment extracts, when summary related information is newly registered, summary extraction information from the registered summary related information.

TABLE 1
<Example of Summary Extraction Information>

| Diagnostic Code | Clinical Information | Number of |
|---|---|---|
| (Disease) | Item | Appearances |
| J153(Bacterial | BT(Body Temperature) | 1 |
| Pneumonia) | | |
| J153 | SpO2(Oxygen Saturation) | 1 |
| J153 | BP(Blood Pressure) | 1 |
| J153 | PR(Pulse Rate) | 1 |
| J153 | BUN(Blood Urea Nitrogen) | 1 |
| J153 | Cre(Creatine) | 1 |
| J153 | CRP(C-Reactive Protein) | 1 |
| J153 | WBC(White Blood Count) | 1 |
| J153 | Antibacterial Agent | 1 |

In the case where summary extraction information is calculated from a history of a series of operations for generating a discharge summary (or conference summary), the summary extraction information obtaining unit 31 detects an operation for selecting and inserting a particular clinical information from the history of a series of operations and the number of appearances thereof is increased by one. Further, the summary extraction information obtaining unit 31 detects an operation for selecting and deleting particular clinical information from the history of a series of operations and the number of appearances thereof is decreased by one. This is because the clinical information deleted from a discharge summary or the like in the middle of the generation thereof is likely to be determined not important for the diagnosis and the clinical information item determined not important for the diagnosis is prevented from being judge important in the subsequent processing.

The item information calculation unit 32 calculates an appearance frequency of each clinical information item, item by item, with respect to each disease as item information based on the summary extraction information (ST03). Note that the item information calculation processing is regularly performed at a predetermined time interval.

The item information calculation unit 32 calculates the appearance frequency of each clinical information item with respect to a given disease by calculating the number of summary extraction information sets and dividing the number of appearances of each clinical information item in the summary extraction information sets by the number of summary extraction information sets present with respect to the given disease. Table 2 shows the number of summary extraction information sets present with respect to each disease obtained by counting the number of summary extraction information sets. Note that one summary extraction information set is extracted from one summary related information set. Tables 3 and 4 illustrate examples of item information sets with respect to the diseases (pneumonia and lung cancer) in which an appearance frequency of each clinical information item is related to the respective diseases based on the summary extraction information.

The item information calculation unit 32 treats a plurality of diseases classified into the same category as one disease and calculates item information with respect to the one disease, as shown in Tables 2, 3, and 4. For example, even in the case where the disease included in the summary extraction information is bacterial pneumonia, the item information calculation unit 32 calculates the appearance frequency of the clinical information item in the summary extraction information by replacing the bacterial pneumonia with pneumonia because the bacterial pneumonia is classified into pneumonia, as shown in Table 1.

TABLE 2
<Category of Disease>

| | Number of Summary Extraction |
|---|---|
| Disease | Information Sets |
| Pneumonia (J15*) | 326 |
| Lung Cancer(C34*) | 1218 |
| Chronic Obstructive | 245 |
| Lung Disease | |
| . . . | . . . |
| Total | 2537 |

TABLE 3
<Item Information (Pneumonia)>

| | | Clinical information | Num. of | Freq. |
|---|---|---|---|---|
| Category | | Item | Appear. | (%) |
| Vital | | BT(Body Temperature) | 326 | 100 |
| | | SpO2(Oxygen Saturation) | 326 | 100 |
| | | BP(Blood Pressure) | 326 | 100 |
| | | PR(Pulse Rate) | 326 | 100 |
| | | RR(Respiration Rate) | 189 | 58 |
| | | . . . | . . . | . . . |
| Blood | General | BUN(Blood Urea Nitrogen) | 321 | 98 |
| Exam. | | Cre(Creatine) | 299 | 92 |
| | | CRP(C-Reactive Protein) | 326 | 100 |
| | | WBC(White Blood Count) | 326 | 100 |
| | | TP(Total Protein) | 37 | 11 |
| | | Uric Acid | 42 | 13 |
| | | . . . | . . . | . . . |
| | Tumor | CEA | 1 | 0 |
| | Marker | SCC Antigen | 1 | 0 |
| | | NSE | 1 | 0 |
| | | . . . | . . . | . . . |

| | | | |
|---|---|---|---|
| Category of | Antibacterial Agent | 321 | 98 |
| Medicine | Anticancer Agent | 0 | 0 |
| | Hormonal Agent | 12 | 4 |
| | Antipyretics, Analgesics, and | 36 | 11 |
| | Anti-inflammatory Agents | | |
| | . . . | . . . | . . . |

TABLE 4
<Item Information (Lung Cancer)>

| | | Clinical information | Num. of | Freq. |
|---|---|---|---|---|
| Category | | Item | Appear. | (%) |
| Vital | | BT | 1218 | 100 |
| | | SpO2 | 973 | 80 |
| | | BP | 1218 | 100 |
| | | PR | 1218 | 100 |
| | | RR | 203 | 17 |
| | | . . . | . . . | . . . |
| Blood | General | BUN(Blood Urea Nitrogen) | 1054 | 87 |
| Exam. | | Cre(Creatine) | 1054 | 87 |
| | | CRP(C-Reactive Protein) | 1054 | 87 |
| | | WBC(White Blood Count) | 1054 | 87 |
| | | TP(Total Protein) | 175 | 14 |
| | | Uric Acid | 155 | 13 |
| | | . . . | . . . | . . . |
| | Tumor | CEA | 554 | 45 |
| | Marker | SCC Antigen | 430 | 35 |
| | | NSE | 392 | 32 |
| | | . . . | . . . | . . . |

| | | | |
|---|---|---|---|
| Category of | Antibacterial Agent | 208 | 17 |
| Medicine | Anticancer Agent | 405 | 33 |
| | Hormonal Agent | 206 | 17 |
| | Antipyretics, Analgesics, and | 0 | 0 |
| | Anti-inflammatory Agents | | |
| | . . . | . . . | . . . |

The display filter generation unit 33 determines a clinical information item included in the calculated item information that satisfies a predetermined condition as an important clinical information item (ST04).

The display filter generation unit 33 determines a clinical information item corresponding to given clinical information as an important clinical information item if the clinical information item satisfies at least one of the following: (condition 1) and (condition 2).

(Condition 1): in the case of a given disease, the appearance frequency of a given clinical information item is greater than or equal to a first threshold value (=60%).
(Condition 2): the likelihood ratio defined by the conditional expression (A) given below is greater than or equal to a second threshold value (=2).
[in the case of a given disease, the conditional probability that the summary extraction information includes given clinical information]/[in the case of a disease other than the given disease, the conditional probability that the summary extraction information includes the given clinical information]--------- (A)

The display filter generation unit 33 determines a clinical information item that satisfies the condition 1 to be an important clinical information item based on the item information shown in Tables 3 and 4. In the examples shown in Tables 3 and 4, important clinical information items determined based on the condition 1 are indicated by bold type.

The display filter generation unit 33 determines based on condition 2 a given clinical information item having a likelihood ratio (evaluation value) defined by the conditional expression (A) greater than or equal to the second threshold value (=2) to be an important clinical information item.

The important clinical information determination method will be described using a specific example. When calculating item information shown in Tables 3 and 4, the item information calculation unit 32 counts the appearance frequency of each clinical information item in all of the summary extraction information sets, as shown in Table 5.

TABLE 5
<Number of Appearances of Clinical Information Items
in All Summary Extraction Information Sets>

| | | |
|---|---|---|
| | Clinical information | |
| Category | Item | Total |

| Vital | | BT(Body Temperature) | 2480 |
|---|---|---|---|
| | | SpO2(Oxygen Saturation) | 2480 |
| | | BP(Blood Pressure) | 2480 |
| | | PR(Pulse Rate) | 2480 |
| | | RR(Respiration Rate) | 420 |
| | | . . . | . . . |
| Blood | General | BUN(Blood Urea Nitrogen) | 2055 |
| Exam. | | Cre(Creatine) | 1949 |
| | | CRP(C-Reactive Protein) | 2261 |
| | | WBC(White Blood Count) | 1878 |
| | | TP(Total Protein) | 360 |
| | | Uric Acid | 288 |
| | | . . . | . . . |
| | Tumor | CEA | 721 |
| | Marker | SCC Antigen | 498 |
| | | NSE | 541 |
| | | . . . | . . . |

| | | |
|---|---|---|
| Category of | Antibacterial Agent | 506 |
| Medicine | Anticancer Agent | 425 |
| | Hormonal Agent | 308 |
| | Antipyretics, Analgesics, and | 184 |
| | Anti-inflammatory Agents | |
| | . . . | . . . |

Using the examples shown in Tables 4 and 5, a specific calculation method of likelihood ratios to be calculated by the conditional expression (A) will be described with respect to a disease (lung cancer) and a clinical information item (hormonal agent), and a disease (lung cancer) and a clinical information item (body temperature).

### Example 1

### Lung Cancer and Hormonal Agent

According to Tables 4 and 5, the [in the case of a given disease, the conditional probability that the summary extraction information includes given clinical information] defined in the numerator of the conditional expression (A) may be calculated as [in the case of lung cancer, the conditional probability that the summary extraction information includes a hormonal agent]=(the disease is lung cancer and the number of appearances of the hormonal agent in the summary extraction information (=206))/(number of summary extraction information sets whose disease is lung cancer (=1218)). Further, the [in the case of a disease other than the given disease, the conditional probability that the summary extraction information includes the given clinical information] defined in the denominator of the conditional expression (A) may be calculated as [in the case of a disease other than lung cancer, the conditional probability that the summary extraction information includes the hormonal agent]=(the number of appearances of the hormonal agent in all of the summary extraction information sets (=308)−the disease is lung cancer and the number of appearances of the hormonal agent in the summary extraction information (=206)/(total number of summary extraction information sets (=2537)−the number of summary extraction information sets whose disease is lung cancer (1218)). Use of these in the calculation of likelihood ratio yields the following:

[in the case of lung cancer, the probability that the summary extraction information includes a hormonal agent]/[in the case of a disease other than lung cancer, the probability that the summary extraction information includes the hormonal agent]=(206/1218)/((308−206)/(2537−1218))=2.2

### Example 2

### Lung Cancer and Body Temperature (BT)

Likewise, the calculation of the likelihood with respect to lung cancer and body temperature BT by the conditional expression (A) may result in the following:

[in the case of lung cancer, the probability that the summary extraction information includes body temperature BT]/[in the case of a disease other than lung cancer, the probability that the summary extraction information includes body temperature BT]=(1218/1218)/(2480−1280)/(2537−1218)=1.0

Likewise, the likelihood ratios defined by the conditional expression (A) based on Tables 2 to 5 may be calculated for pneumonia and lung cancer as shown in Tables 6 and 7 respectively. Table 6 shows a likelihood ratio of each clinical information item calculated by the conditional expression (A) with respect to pneumonia, while Table 7 shows a likelihood ratio of each clinical information item calculated by the conditional expression (A) with respect to lung cancer. Clinical information items having likelihood ratios greater than or equal to the second threshold value (=2) and determined to be important clinical information items are indicated by bold type in Tables 6 and 7.

TABLE 6
<Likelihood Ratio(Pneumonia)>

| | | Clinical Information | Likelihood |
|---|---|---|---|
| Category | | Item | Ratio |
| Vital | | BT(Body Temperature) | 1.0 |
| | | SpO2(Oxygen Saturation) | 1.0 |
| | | BP(Blood Pressure) | 1.0 |
| | | PR(Pulse Rate) | 1.0 |
| | | RR(Respiration Rate) | 5.5 |
| | | . . . | . . . |
| Blood | General | BUN(Blood Urea Nitrogen) | 1.3 |
| Exam. | | Cre(Creatine) | 1.2 |
| | | CRP(C-Reactive Protein) | 1.1 |
| | | WBC(White Blood Count) | 1.4 |
| | | TP(Total Protein) | 0.8 |
| | | Uric Acid | 1.2 |
| | | . . . | . . . |
| | Tumor | CEA | 0.0 |
| | Marker | SCC Antigen | 0.0 |
| | | NSE | 0.0 |
| | | . . . | . . . |

| | | |
|---|---|---|
| Category of | Antibacterial Agent | 11.8 |
| Medicine | Anticancer Agent | 0.0 |
| | Hormonal Agent | 0.3 |
| | Antipyretics, Analgesics, and | 0.3 |
| | Anti-inflammatory Agents | |
| | . . . | . . . |

TABLE 7
<Likelihood Ratio(Lung Cancer)>

| | | Clinical information | Likelihood |
|---|---|---|---|
| Category | | Item | Ratio |
| Vital | | BT(Body Temperature) | 1.0 |
| | | SpO2(Oxygen Saturation) | 0.7 |
| | | BP(Blood Pressure) | 1.0 |
| | | PR(Pulse Rate) | 1.0 |
| | | RR(Respiration Rate) | 1.0 |
| | | . . . | . . . |
| Blood | General | BUN(Blood Urea Nitrogen) | 1.1 |
| Exam. | | Cre(Creatine) | 1.3 |
| | | CRP(C-Reactive Protein) | 0.9 |
| | | WBC(White Blood Count) | 1.4 |
| | | TP(Total Protein) | 1.0 |
| | | Uric Acid | 1.3 |
| | | . . . | . . . |
| | Tumor | CEA | 3.6 |
| | Marker | SCC Antigen | 6.8 |
| | | NSE | 2.8 |
| | | . . . | . . . |

| | | |
|---|---|---|
| Category of | Antibacterial Agent | 0.8 |
| Medicine | Anticancer Agent | 21.9 |
| | Hormonal Agent | 2.2 |
| | Antipyretics, Analgesics, and | 0.0 |
| | Anti-inflammatory Agents | |
| | . . . | . . . |

In Table 7, a comparison will now be made between the likelihood ratio calculated with respect to the disease (lung cancer) and clinical information item (hormonal agent), and the likelihood ratio calculated with respect to the disease (lung cancer) and clinical information item (body temperature). The likelihood ratio calculated with respect to the disease (lung cancer) and clinical information item (hormonal agent) shows that the probability that the summary extraction information includes the hormonal agent in the case of lung cancer is 2.19 times the probability that the summary extraction information includes the hormonal agent in the case of a disease other than lung cancer. From this it can be presumed that the clinical information item of hormonal agent is an item that is attracting particular attention for the disease of lung cancer. The clinical information item having a low appearance frequency but is included in the summary related information of only a particular disease is considered to be important for the particular disease, so that the likelihood ratio described above allows a clinical information item assumed to be important for a given disease to be appropriately presumed, whereby a clinical information item important and unique to a disease may be determined appropriately as an important clinical information item.

In the mean time, the likelihood ratio calculated with respect to the disease (lung cancer) and clinical information item (body temperature) shows that the probability that the summary extraction information includes the body temperature (BT) in the case of lung cancer is 1.0 times the probability that the summary extraction information includes body temperature (BT) in the case of a disease other than lung cancer. That is, the probability that the body temperature is included in the summary extraction information in the case of a disease other than lung cancer is identical to the probability that the body temperature is included in the summary extraction information in the case of lung cancer and it can be said that the clinical information item of BT is an item that is not attracting particular attention for the disease of lung cancer in comparison with other diseases.

As described above, the likelihood ratio represents how large the [conditional probability that the summary extraction information includes a given clinical information item in the case of a given disease] is with respect to [conditional probability that the summary extraction information includes the given clinical information item in the case of a disease other than the given disease]. Thus, a clinical information item having a large likelihood ratio can be presumed to be a clinical information item particularly having a close connection with the disease. Therefore, the use of the likelihood ratio as the evaluation value of importance of a clinical information item to determine a clinical information item having a likelihood ratio greater than a predetermined threshold value allows a clinical information item expected to have a close connection with a given disease to be distinguished easily. The threshold value (second threshold value) with respect to the likelihood ratio may be set arbitrarily as long as it allows the depth of connection of a clinical information item to a disease (certainty that the clinical information item corresponds to the disease) to be evaluated relatively large based on the value of the likelihood ratio and, for example, a value of not less than 1.5 is preferable and a value of not less than 2.0 is more preferable.

For the simplicity of calculation when calculating the likelihood ratio, if the number of diseases is relatively small and the [in the case of a disease other than the given disease, the conditional probability that the summary extraction information includes the given clinical information] can be regarded as identical to the [probability that the summary information includes the given clinical information with respect to the total number of diseases], the likelihood ratio may be calculated using the [probability that the summary information includes the given clinical information with respect to the total number of diseases] instead of the [in the case of a disease other than the given disease, the conditional probability that the summary extraction information includes the given clinical information].

Here, the display filter generation unit 33 determines a clinical information item having a likelihood ratio greater than or equal to a value of 2 to be an important clinical information item. The clinical information items indicated by bold type in Tables 6 and 7 are important clinical information items extracted based on the condition 2.

Then, the display filter generation unit 33 relates an important clinical information item extracted based on the condition 1 and an important clinical information item extracted based on the condition 2 to a disease, thereby generating a display filter in which the important clinical information items are related to the disease (ST05). Examples of generated filters are shown in Tables 8 and 9 below. Table 8 shows a display filter corresponding to pneumonia and Table 9 shows a display filter corresponding to lung cancer.

TABLE 8
<Display Filter(Pneumonia)>

| Category | | Important Clinical Information Item |
|---|---|---|
| Vital | | BT(Body Temperature) |
| | | SpO2(Oxygen Saturation) |
| | | BP(Blood Pressure) |
| | | PR(Pulse Rate) |
| | | RR(Respiration Rate) |
| Blood | General | BUN(Blood Urea Nitrogen) |
| Exam. | | Cre(Creatine) |
| | | CRP(C-Reactive Protein) |
| | | WBC(White Blood Count) |

| | |
|---|---|
| Category of Medicine | Antibacterial Agent |

TABLE 9
<Display Filter(Lung Cancer)>

| Category | | Important Clinical Information Item |
|---|---|---|
| Vital | | BT(Body Temperature) |
| | | SpO2(Oxygen Saturation) |
| | | BP(Blood Pressure) |
| | | PR(Pulse Rate) |
| Blood | General | BUN(Blood Urea Nitrogen) |
| Exam. | | Cre(Creatine) |
| | | CRP(C-Reactive Protein) |
| | | WBC(White Blood Count) |
| | Tumor | CEA |
| | Marker | SCC Antigen |
| | | NSE |

| | |
|---|---|
| Category of Medicine | Anticancer Agent |
| | Hormonal Agent |

### <Display Stage>

FIG. 4 is a flowchart illustrating a flow of processing performed in the display stage. Here, the flow of processing in the display stage will be described by taking, as an example, the case in which a diagnosis and treatment department doctor extracts, based on a possible disease of a display target patient, important clinical information of the display target patient and displays the extracted information for diagnosis from the diagnosis and treatment department terminal 2 with reference to FIG. 4.

First, the display target information obtaining unit 21 receives input from the doctor through the input device 23 and obtains a patient ID and a possible disease of the display target patient. Then, the display target information obtaining unit 21 loads an electronic medical record or an examination result, which is the clinical information of the display target patient, in a memory of the diagnosis and treatment department terminal 2 (ST11).

Next, the display control unit 22 obtains a display filter corresponding to the disease of the display target patient (ST12). Then, the display control unit 22 obtains an important clinical information item registered in the display filter and extracts clinical information of the display target patient corresponding to the important clinical information item from the clinical information loaded in the memory (ST13). The display control unit 22 displays the extracted clinical information on the display unit 24 according to a predetermined display option in which a display position, display method, and the like are preset (ST14).

Next, the change information obtaining unit 27 receives a user operation history through the input device with respect to the displayed clinical information of the display target patient. If the operation history does not include any operation for changing the displayed clinical information from display to non-display or from non-display to display, the processing is completed (ST15: NO). On the other hand, if the operation history includes an operation for changing the displayed clinical information from display to non-display or from non-display to display (ST15: YES), change information obtaining unit 27 relates, based on the operation, to the clinical information item on which the operation has been performed whether the clinical information item is changed from display to non-display or from non-display to display, and stores the result in the summary related information database 3A, as change information (ST16).

Based on the change information stored in the summary related information database 3A, if the clinical information item on which the operation has been performed is changed from the display to non-display, the display filter change unit 28 deletes the clinical information item from the display filter. On the other hand, if the clinical information item on which the operation has been performed is changed from the non-display to display, the display filter change unit 28 adds the clinical information item to the display filter as an important clinical information item. Then, the display filter change unit 28 stores the changed display filter in the summary related information database 3A before terminating the processing (ST17).

According to the present embodiment, an important clinical information item is determined based only on the summary related information of clinical information of a plurality of cases. As it is thought that the treatment result summary and treatment review summary summarize clinical information determined by the user to be important for a disease of a patient and for determining the disease, it is less likely that clinical information not related to the diagnosis of the disease is included and it is very likely that only the clinical information considered to be important for the diagnosis of the disease is included in such summaries. Thus, by determining an important clinical information item with respect to each disease based on the treatment result summary, treatment review summary, and the history of a series of operations for generating these summaries, erroneous determination of clinical information not related to the diagnosis of the disease to be important clinical information may be prevented. Thus, the display filter may be generated by determining an important clinical information item through appropriate discrimination of important clinical information from the other clinical information, and the use of the filter may reduce the efforts of the user to retrieve and edit important clinical information of the display target patient, whereby only important clinical information may be displayed accurately and easily. Further, a user not having expert knowledge for medical diagnosis, as well as doctors, may easily retrieve and display important clinical information of the display target patient. Further, the display of the clinical information of the display target patient by reducing unnecessary clinical information allows doctors to understand important clinical information easily and to carry out the diagnosis effectively.

According to the technique described in Japanese Unexamined Patent Publication No. 2006-271541, a distinction can not be made between clinical information selected by circumstances unique to the patient included in the operation history and important clinical information corresponding to the disease, but according to the present embodiment, it is less likely that the important clinical information is determined by the circumstances of one patient since summary information of a plurality of patients is used. Consequently, the important clinical information item may be distinguished more accurately than in the case where clinical information to be displayed is determined based only on the history of one patient.

According to the embodiment described above, only clinical information corresponding to the important clinical information item among the clinical information of the display target patient is displayed, so that the display screen is avoided to become complicated with unnecessary information, which may assist doctors in understanding the clinical information of the display target patient and improving the diagnostic efficiency. In order to further enhance the advantageous effects, an arrangement may be adopted in which a display level for setting a display step is set to each important clinical information item by the display filter generation unit 33 and display mode is changed by the display control unit 22 according to the display level. As for the display step setting method, any arbitrary method may be used. Further, as for the display step changing method, any method may be used as long as it is capable of displaying an important clinical information item in a distinguishable manner according to the display step.

As an example, the display filter in the aforementioned embodiment may be a display filter in which an important clinical information item and an evaluation value (appearance frequency or likelihood ratio described above) used for the determination of the important clinical information item to a disease. Then, the display control unit 22 may perform a detailed display for important clinical information having an appearance frequency greater than or equal to a third threshold value (80%) and a simplified display for important clinical information having an appearance frequency less than the third threshold value (80%). Further, the display control unit 22 may perform a detailed display for important clinical information having a likelihood ratio greater than or equal to a fourth threshold value (3.0) and a simplified display for important clinical information having a likelihood ratio less than the fourth threshold value (3.0). In this case, there is no need to separately set a display level and relates to the display filter and doctors may easily understand an important clinical information item having particularly high appearance frequency (or likelihood ratio). Preferably, the important clinical information item in a simplified display is switchable to a detailed display by a click operation.

In the case where the summary related information is a history of a series of operations for generating a treatment result summary or the like, the summary extraction information obtaining unit 31 is preferable to be a unit that calculates summary extraction information using an operation for selecting and inserting clinical information into the treatment result summary or the like, or an operation for selecting and deleting clinical information from the treatment result summary or the like in the series of operations for generating the treatment result summary. In the case where the summary related information is a history of a series of operations for generating a treatment result summary or the like, the series of operations are considered to be performed by the user for generating the treatment result summary by judging whether or not the operation target clinical data are important for the diagnosis or treatment, so that information required for the diagnosis or treatment may be extracted accurately. The operation for selecting and inserting clinical information into a treatment result summary or the operation for selecting and deleting clinical information from a treatment result summary, in particular, is an operation performed by the user by judging whether or not the operation target clinical information is important, so that if an important clinical information item is determined based on the operation for selecting and inserting clinical information into the treatment result summary or the like, or the operation for selecting and deleting clinical information from the treatment result summary or the like, an operation presumed to be performed by the user by judging important may be appropriately identified and information required for the diagnosis may be extracted more accurately for presenting to the user.

Further, when obtaining summary extraction information, it is preferable that the number of appearances of the clinical information in the summary related information is increased by the “operation for selecting and inserting the clinical information into a treatment result summary or the like” while the number of appearances of the clinical information in the summary related information is not increased or decreased by the “operation for selecting and deleting the clinical information from a treatment result summary or the like”, as in the aforementioned embodiment. This is because the clinical information deleted from a treatment result summary or the like in the middle of the generation thereof is likely to be judged not important for the diagnosis and the clinical information judged not important for the diagnosis is prevented from being judge important in the subsequent processing.

In the aforementioned embodiment, the summary extraction information and item information are calculated with a plurality of diseases belonging to the same category being treated as one disease. Consequently, even in the case where the number of summary related information sets is small with respect to each disease, it can be thought that it is highly likely that a plurality of diseases belonging to the same category shares an important clinical information item in common, so that an important clinical information item may be determined appropriately by effectively using the summary related information and the like of the other disease included in the same category. Further, generation of a display filter for each of a wide variety of disease names may prevent increase in the burden for collecting summary related information with respect to the corresponding disease. Further, as an important clinical information item is determined with respect to each category of diseases, so that the same display filter may be practically used widely for a plurality of diseases belonging to the same category. The “same category” as used herein may be a category classified by the type of the cause or symptom of the disease, and it may be a category further classified by the seriousness of the disease.

In the aforementioned embodiment, the clinical information includes medication information representing a medicine and the summary extraction information obtaining unit 31 calculates the summary extraction information by relating medication information to each disease with a plurality of medicines classified into the same category being treated as one medicine. Consequently, even in the case where the number of summary related information sets is small with respect to each medicine, it can be thought that it is highly likely that a plurality of medicines belonging to the same category has similar treatment purpose or effect, so that an important clinical information item may be determined appropriately by effectively using the clinical information of the other medicine included in the same category. Preferably, the classification of medicines may be made by the effectiveness of the medicine or a major component of the medicine.

Further, in the aforementioned embodiment, an important clinical information item is determined using the likelihood ratio defined by the conditional expression (A) as the evaluation value. The clinical information item having a low appearance frequency but is included in the summary related information of only a particular disease is considered to be important, so that the likelihood ratio described above allows a clinical information item assumed to be important for a given disease to be appropriately presumed, whereby a display filter in which an important clinical information item unique to a disease is determined as an important clinical information item may be generated.

As the likelihood ratio is used for calculating an important clinical information item, the important clinical information item may be determined by reflecting both the probability that the important information is included in the case of a given disease and the probability that the important information is included in the case of not the give disease. This allows an important clinical information item more accurately than in the case where the important clinical information is determined based only on the probability corresponding to the give disease. Further, even in the case where the number of summary related information sets of a patient store in advance is small, an important clinical information item may be determined relatively accurately.

Further, in the aforementioned embodiment, the display filter is changed based on the change information. The operation for changing important clinical information from display to non-display or operation for changing important clinical information from non-display to display indicated by the change information is considered to be an operation for modifying an automatically extracted important clinical information item based on the judgment made by the user. Therefore, by appropriately feed-backing the modification of important clinical information item made by the user to modify the display filter, the display filter becomes a display filter in which a more appropriate important clinical information item is determined, thereby allowing appropriate important clinical information to be displayed.

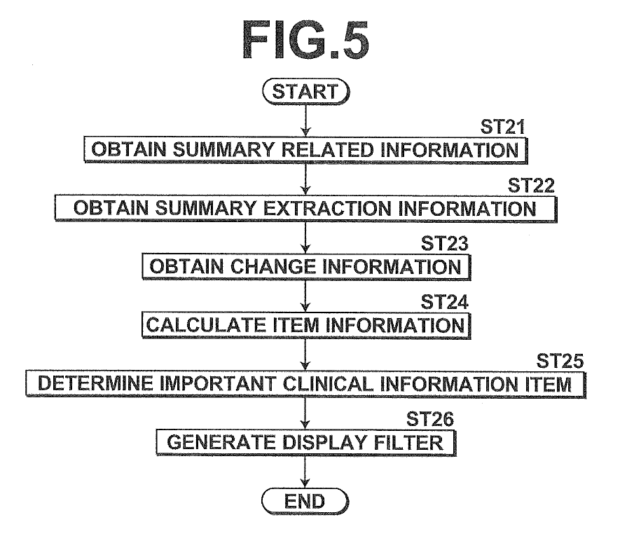

Likewise, as an appropriate important clinical information item is determined by appropriately feed backing the modification of important clinical information item made by the user, an arrangement may be adopted, as a modification of the clinical information display apparatus 1 of the aforementioned embodiment, in which the display filter change unit 28 is omitted and, if change information is obtained by the change information obtaining unit 27, the item information calculation unit 32 calculates the item information by calculating a degree of appearance of each clinical information item with respect to each disease using the change information and also based on the display target disease and change information corresponding to the display target disease. FIG. 5 illustrates a flow of processing performed in the display filter generation stage in the modification of the clinical information display apparatus 1. Processing common to that of the aforementioned embodiment is omitted to avoid redundant description.

As shown in FIG. 5, the summary extraction information obtaining unit 31 obtains summary related information by performing identical processing to that of ST01 in FIG. 3 (ST21). Then, the summary extraction information obtaining unit 31 counts the number of appearances of each clinical information item in the summary extraction information by performing identical processing to that of ST02 in FIG. 3 based on the summary related information (ST22).

Next, the item information calculation unit 32 obtains change information which includes a clinical information item and information representing whether the clinical information item is changed from the display to non-display or from non-display to display related to each other from the summary related information database 3A (ST23).

Then, based on both the summary extraction information and change information, the item information calculation unit 32 sums the number of appearances of a clinical information item in the summary extraction information and the number of appearances of the clinical information item in the change information. Here, for a clinical information item changed from display to non-display, the number of appearances thereof in the change information is calculated as minus one and for a clinical information item changed from non-display to display, the number of appearances thereof in the change information is calculated as plus one. Then, the item information calculation unit 32 calculates an appearance frequency of each clinical information item, item by item, with respect to each disease as item information (ST24).

Next, the display filter generation unit 33 determines an important clinical information item by performing identical processing to that of ST04 (ST25) and generates a display filter by performing identical processing to that of ST05 (ST26). Processing performed in the display stage and processing performed in the summary related information generation stage are identical to those of the aforementioned embodiment and will not be elaborated upon further here. The change information obtaining processing in ST23 may be performed prior to or in parallel with the summary related information obtaining processing in ST21 and the summary extraction information obtaining processing in ST22.

In the aforementioned embodiment, the item information calculation processing and display filter generation processing are set to be performed regularly at a predetermine time but they can also be performed at an arbitrary timing according to a request for adding a case from each terminal. Further, the present invention is not limited to the aforementioned embodiment and the summary related information extraction processing, item information calculation processing, and display filter generation processing are not necessary to be performed continuously in the display filter generation stage, and each processing may be performed at arbitrary time intervals.

In the aforementioned embodiment, the clinical information display apparatus 1 may have a configuration in which the change information obtaining unit 27 and display filter change unit 28. Further, in the aforementioned embodiment, the clinical information display apparatus 1 may have a configuration in which the history obtaining unit 26 is omitted and the summary related information may be formed of only a diagnostic summary or a treatment review summary. Further, the summary related information generation unit 25 may be configured by another terminal connected to the network 7.

The present invention is not limited to the present embodiment and a portion or all components of the clinical information display apparatus may be configured by one workstation or one or more workstations, a server, and a storage unit linked via a network. Each unit or device is controlled by a program installed from a CD-ROM or the like and performs the clinical information display described in the specification. Further, the program may be a program downloaded from a storage unit of a server linked via a network, such as the Internet, and installed.

It should be appreciated that each embodiment described above is only for the purpose of illustrating one aspect of the present invention and various modifications and applications may be made without departing from the spirit and scope of the present invention.

What is claimed is:

1. A clinical information display apparatus, comprising:
a summary extraction information obtaining unit for obtaining, with respect to a plurality of patients, at least one of (1) a treatment result summary in which a disease and clinical information of a patient is summarized for indicating a diagnostic result or a treatment result, (2) a treatment review summary in which a possible disease and clinical information of the patient is summarized for reviewing diagnosis or treatment (3) a history of a series of operations for generating the treatment result summary, and (4) a history of a series of operations for generating the treatment review summary as summary related information, and obtaining summary extraction information in which each disease and each clinical information item representing a type of clinical information extracted from the obtained summary related information of the plurality of patients are related;
an item information calculation unit for calculating a degree of appearance of each clinical information item, item by item, with respect to each disease as item information based on the summary extraction information;
a display filter generation unit for determining a clinical information item whose calculated item information satisfies a predetermined condition as an important clinical information item and generating a display filter in which a disease and an important clinical information item corresponding to the disease are related; and
a display control unit for obtaining a disease of a display target patient as a display target disease and obtaining clinical information of the display target patient corresponding to the important clinical information item for display on a display unit based on a display filter corresponding to the obtained display target disease.

2. The clinical information display apparatus of claim 1, wherein the summary extraction information obtaining unit is a unit that calculates the summary extraction information using an operation for selecting and inserting clinical information into the treatment result summary and/or the treatment review summary and an operation for selecting and deleting clinical information from the treatment result summary and/or the treatment review summary in the history of a series of operations for generating the treatment result summary and/or the history of a series of operations for generating the treatment review summary.

3. The clinical information display apparatus of claim 1, wherein:
the item information is information representing an appearance frequency of each clinical information in the summary extraction information; and
the display filter generation unit is a unit that determines a clinical information item whose appearance frequency is greater than a predetermined threshold value to be an important clinical information item based on the item information.

4. The clinical information display apparatus of claim 1, wherein the display filter generation unit is a unit that further determines an important clinical information item of the predetermined disease based on a likelihood ratio obtained by dividing a conditional probability of appearance of the clinical information item in a case corresponding to the predetermined disease by a conditional probability of appearance of the clinical information item in a case not corresponding to the predetermined disease based on the summary extraction information.

5. The clinical information display apparatus of claim 1, further comprising:
a change information obtaining unit for obtaining, based on clinical information of the display target patient displayed by the display control unit, a clinical information item changed from display to non-display or a clinical information item changed from non-display to display as change information; and
a display filter change unit for changing, based on the display target disease and change information corresponding to the display target disease, the important clinical information item of the display filter.

6. The clinical information display apparatus of claim 1, wherein:
the apparatus further comprises a change information obtaining unit for obtaining, based on clinical information of the display target patient displayed by the display control unit, a clinical information item changed from display to non-display or a clinical information item changed from non-display to display as change information; and
the item information calculation unit is a unit that calculates the item information by calculating a degree of appearance of each clinical information item with respect to each disease based also on the display target disease and change information corresponding to the display target disease.

7. The clinical information display apparatus of claim 1, wherein the clinical information includes medication information representing a medicine and the summary extraction information obtaining unit is a unit that calculates the summary extraction information by relating the medication information to each disease with a plurality of medicines classified into the same category being treated as one medicine.

8. The clinical information display apparatus of claim 1, wherein an important clinical information item is related to each of a plurality of display steps in the display filter and display mode of the clinical information corresponding to the important clinical information item of the display target patient is changed according to the display step.

9. The clinical information display apparatus of claim 1, wherein the item information calculation unit is a unit that calculates the item information with respect to each disease with a plurality of diseases classified into the same category being treated as one disease.

10. A clinical information display method for use with a clinical information display apparatus which includes a summary extraction information obtaining unit, an item information calculation unit, a display filter generation unit, and a display control unit, the method comprising the steps of:
obtaining, with respect to a plurality of patients, at least one of (1) a treatment result summary in which a disease and clinical information of a patient is summarized for indicating a diagnostic result or a treatment result, (2) a treatment review summary in which a possible disease and clinical information of the patient is summarized for reviewing diagnosis or treatment (3) a history of a series of operations for generating the treatment result summary, and (4) a history of a series of operations for generating the treatment review summary as summary related information and obtaining summary extraction information in which each disease and each clinical information item representing a type of clinical information extracted from the obtained summary related information of the plurality of patients are related;
calculating a degree of appearance of each clinical information item, item by item, with respect to each disease as item information based on the summary extraction information;
determining a clinical information item whose calculated item information satisfies a predetermined condition as an important clinical information item and generating a display filter in which a disease and an important clinical information item corresponding to the disease are related; and
obtaining a disease of a display target patient as a display target disease and obtaining clinical information of the display target patient corresponding to the important clinical information item for display on a display unit based on a display filter corresponding to the obtained display target disease.

11. A non-transitory recording medium on which is recorded a clinical information display program for causing a computer to function as:
a summary extraction information obtaining unit for obtaining, with respect to a plurality of patients, at least one of (1) a treatment result summary in which a disease and clinical information of a patient is summarized for indicating a diagnostic result or a treatment result, (2) a treatment review summary in which a possible disease and clinical information of the patient is summarized for reviewing diagnosis or treatment (3) a history of a series of operations for generating the treatment result summary, and (4) a history of a series of operations for generating the treatment review summary as summary related information, and obtaining summary extraction information in which each disease and each clinical information item representing a type of clinical information extracted from the obtained summary related information of the plurality of patients are related;
an item information calculation unit for calculating a degree of appearance of each clinical information item, item by item, with respect to each disease as item information based on the summary extraction information;
a display filter generation unit for determining a clinical information item whose calculated item information satisfies a predetermined condition as an important clinical information item and generating a display filter in which a disease and an important clinical information item corresponding to the disease are related; and
a display control unit for obtaining a disease of a display target patient as a display target disease and obtaining clinical information of the display target patient corresponding to the important clinical information item for display on a display unit based on a display filter corresponding to the obtained display target disease.
